(19) United States
(12) Patent Application Publication
(10) Pub. No.: US 2010/0185603 A1
(43) Pub. Date: Jul. 22, 2010

(54) TECHNIQUES FOR USING DATABASE RULE RESULTS

(76) Inventors: Paul H. Phibbs, Escondido, CA (US); Marianne Ruegsegger, Escondido, CA (US); Linette Draper, Escondido, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/351,501

(22) Filed: Jan. 9, 2009

(51) Int. Cl. G06F 17/30; G06F 7/00

(52) U.S. Cl. 707/721; 707/E17.014

(57) ABSTRACT

Techniques for using database rule results are provided. Structure Query Language (SQL) statements are parsed for multiple metric calculations. Multiple rules are parsed and evaluated within the SQL statements to produce results. The results are used by other portions of the SQL statements as a source or a driver for those other portions of the SQL statements.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the example screen shots for a report tool as described below and in any drawings hereto: Copyright© 2008, Teradata, Inc. All Rights Reserved.

### BACKGROUND

Enterprises now track all aspects of their business electronically. Every transaction with a customer, information about the customer, inventory, capital, expenses, etc. are captured, indexed, and stored in an enterprise's database. Very quickly the enterprise's database becomes enormous in size having a plethora of information. Accordingly, enterprises are increasingly relying on their information for driving and managing all aspects of their business operations.

In fact, enterprises often develop reports and real-time statistics from their databases. Typically, the interface for achieving these reports and statistics is a Structured Query Language (SQL). Often, analysts develop complex SQL statements that execute against the database for purposes of gaining different insight into the details of the business.

These SQL statements can include a variety of nested rules. Unfortunately, users are generally not permitted to have multiple rule evaluations as a source or a driver to other portions of SQL statements.

So, users may have to iterate and may have to develop many different sets of SQL statements to account for multiple rule evaluations that may be needed. This is time consuming and inefficient.

As a result, improved techniques for using database rule results are needed.

### SUMMARY

In various embodiments, techniques for using database rule results are provided. More particularly, a method for using database rule results is provided. Specifically, Structured Query Language (SQL) statements are received and a first rule and a second rule are identified in the SQL statements. Next, the first rule and the second rule are evaluated against a database and results are provided to other portions of the SQL statement for processing.

### BRIEF DESCRIPTION OF THE DRAWINGS

FIG. 1 is a diagram of a method for using database rule results, according to an example embodiment.

FIG. 2 is a diagram of another method for using database rule results, according to an example embodiment.

FIG. 3 is a diagram of a database rule results system, according to an example embodiment.

### DETAILED DESCRIPTION

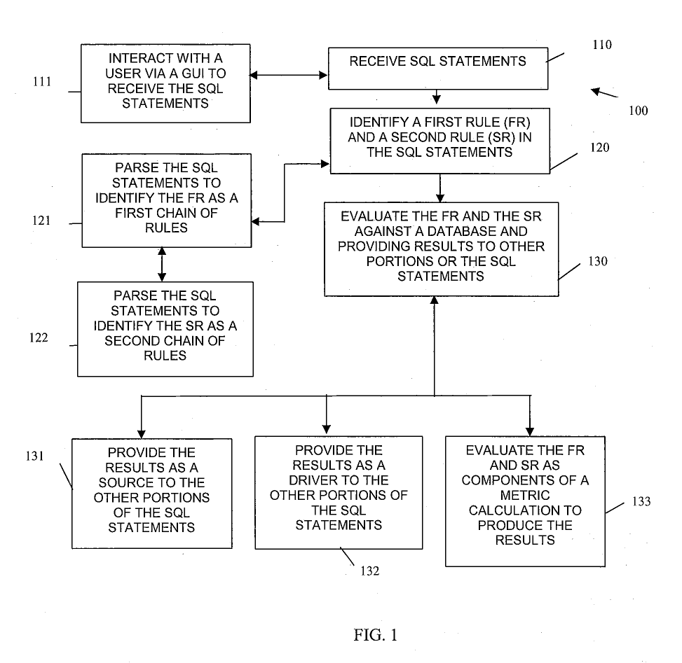

FIG. 1 is a diagram of a method 100 for using database rule results, according to an example embodiment. The method 100 (herein after referred to as “database rule service”) is implemented in machine-accessible or computer-readable storage medium as instructions that are executed by one or more machines (processors, computers, etc.). Moreover, the database rule service is accessible over a network. The network may be wired, wireless, or a combination of wired and wireless.

A “database” as used herein refers to a relational database. In an embodiment, the database uses a Structured Query Language (SQL) interface.

A “statement” is a set of SQL operations that are capable of being processed by a database's Application Programming Interface (API) to perform database operations, such as queries. The results associated with processing the statement(s) can be reports, statistics, other database tables, etc.

A “rule” is a conditional comparison identified in a statement, such as If X then Y or When X Do Y, and the like. Rules can have labels and can be accessed by reference or via a name from statements and some rules can incorporate other rules, such as When (Rule X) Do (Rule Y), etc. So, rules can be accessed by reference, nested, simple, complex, etc., and the rules are embedded in statements.

It is within this initial context that the processing associated with the rule ordering service is now discussed in detail.

At 110, the database rule service receives Structured Query Language (SQL) statements. The database rule service can acquire or receive the SQL statements in a variety of manners.

For example, at 111, the database rule service interacts with a user via a graphical user interface (GUI) application to receive and define the SQL statements. In other cases, the SQL statements are received as part of an application of via a command submitted by the user.

At 120, the database rule service identifies a first rule and a second rule from the SQL statements.

As an example, consider that the database rule service is a profitability analytic service that uses an SQL engine to select user-defined rules to generate SQL for purposes of calculating income and expense metrics. Examples of metrics include Other Revenue (OR), Indirect Expense (IE), Direct Expense (DE), Allocated Capital (AC), and/or Risk Provision (RP). The database rule service permits a user to use the same profit component selection for multiple previous rules as the source or the driver to the remaining portions of the SQL statements. Additionally, the database rule service permits a user to use cross-profit component selection of previous rules as the driver to the remaining portions of the SQL statements.

So, at 120, the database rule service identifies multiple rules within the SQL statements that are combined and used as sources or drivers for remaining portions of the SQL statements.

When multiple previous rules are used to create a source or a driver, the database rule service sums the results (as discussed below). For example, DE, IE, and RP results might be stored as a positive number, although these reflect expense elements. So, when the database rule service sums the previous rules, the database rule service applies an appropriate sign to the incoming value, so that the summing of the previous rules can be done properly.

According to an embodiment, at 121, the database rule service parses the SQL statements to identify the first rule as a first chain of rules. That is, the first rule is actually a chain of rules.

Similarly, at 122, the database rule service parses the SQL statements to identify the second rule as a second chain of rules that are different from the first chain of rules. Nested rule processing is permissible.

At 130, the database rule service evaluates the first rule and the second rule against a database and provides results associated with that evaluation to other portions of the SQL statements for further processing.

In one case, at 131, the database rule service provides the results as a source to the other portions of the SQL statements.

In another case, at 132, the database rule service provides the results as a driver to the other portions of the SQL statements.

According to an embodiment, at 133, the database rule service evaluates the first rule and the second rule as component pieces of a metric calculation when producing the results. So, the rules can be nested within a metric calculation and the results are uses as a source or driver to the other remaining SQL statements that are processed.

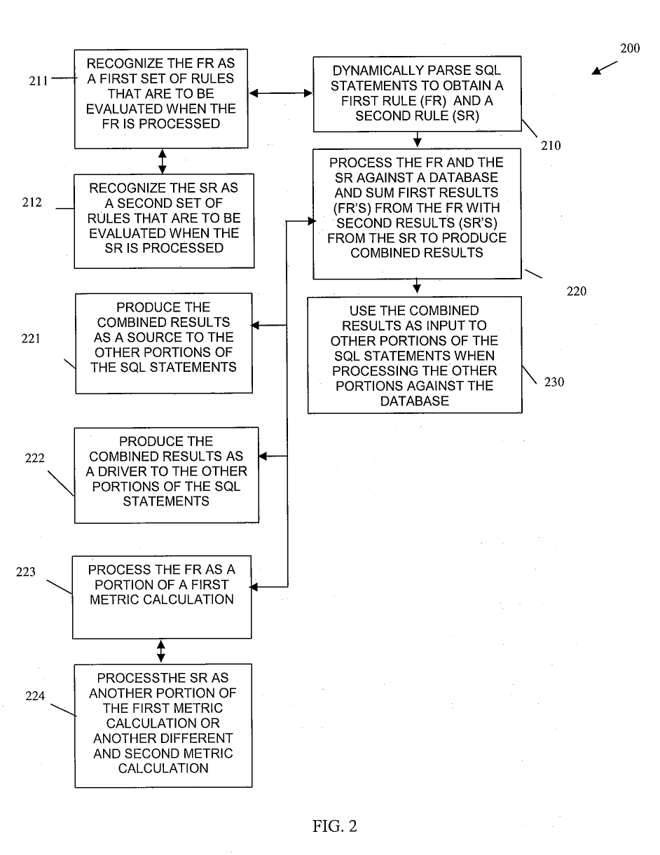

FIG. 2 is a diagram of another method 200 for using database rule results, according to an example embodiment. The method 200 (hereinafter referred to as “rule results service”) is implemented in a machine-accessible and computer-readable storage medium as instructions that when executed by a machine (processor, computer, etc.) performs the processing depicted in FIG. 2. Moreover, rule results service is operational over a network, which may be wired, wireless, or a combination of wired and wireless.

The rule results service provides another and in some cases enhanced perspective to the database rule service represented by the method 100 of the FIG. 1, discussed in detail above.

At 210, the rule results service dynamically parses the SQL statements to identify a first rule and a second rule embedded within the SQL statements.

In some instances, at 211, the rule results service recognizes the first rule as a first set of sub rules that are to be processed when the first rule is processed or evaluated.

In still another case, at 212, the rule results service recognizes the second rule as a second set of sub rules that are to be processed when the second rule is processed or evaluated.

At 220, the rule results service processes or evaluates the first rule to produce first results and the second rule to produce second results. The first results and second results are then summed to produce combined results.

According to an embodiment, at 221, the rule results service produces the combined results as a source for other remaining portions of the SQL statements that are to be processed.

In an alternative case, at 222, the rule results service produces the combined results as a driver for other remaining portions of the SQL statements that are to be processed.

In an embodiment, at 223, the rule results service processes the first rule as a portion of a first metric calculation included within the SQL statements.

Continuing with the embodiment at 223 and at 224, the rule results service processes the second rule as another portion of the first metric calculation or as portion of a second and different metric calculation included within the SQL statements.

At 230, the rule results service uses the combined results as input to other remaining portions of the SQL statements when processing the other remaining portions of the SQL statements against the database.

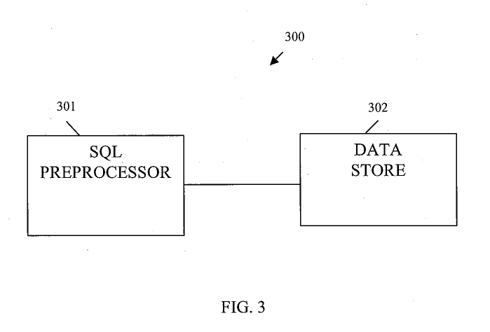

FIG. 3 is a diagram of a database rule results system 300, according to an example embodiment. The database rule results system 300 is implemented in a machine-accessible and computer-readable storage medium as instructions that when executed by a machine(s) (processor(s), computer(s), etc.) performs a variety of processing, such as the processing discussed in detail above with reference to the methods 100 and 200 of the FIGS. 1 and 2.

The database rule results system 300 includes a SQL preprocessor 301 and a database 302. Each of these and their interactions with one another will now be discussed in detail.

The SQL preprocessor 301 is implemented in a computer-readable storage medium and executed by a processor of a network. Example aspects of the SQL preprocessor 301 were presented in detail above with reference to the methods 100 and 200 of the FIGS. 1 and 2, respectively. Moreover, an example implementation of the SQL preprocessor 301 is presented below after the discussion of the FIG. 3.

The SQL preprocessor 301 iterates SQL statements to automatically and dynamically identify and evaluate multiple rules against the database 302 to produce combined results that feed other portions of the SQL statements when those other portions of the SQL statements are processed.

According to an embodiment, the SQL preprocessor 301 iterates the SQL statements to process multiple sets of sub rules for each of the metric rules.

In another embodiment, the SQL preprocessor 301 feeds the combined results as a source input to the other portions of the SQL statements.

In an alternative situation, the SQL preprocessor 301 feeds the combined results as a driver to the other portions of the SQL statements.

In still another case, the SQL preprocessor 301 interacts with a user via a GUI to interactively acquire the SQL statements.

The database 302 is implemented in a computer-readable storage medium and is accessible to the SQL preprocessor 301. Example aspects of the database 302 were presented above with reference to the methods 100 and 200 of the FIGS. 1 and 2, respectively.

According to an embodiment, the database 302 is a data warehouse that includes a collection of databases logically organized and accessible as a single unit.

It is understood that other embodiments may be used to achieve the teachings presented herein and above and that the example source code presented below is but one implementation capable with the teachings presented. The source code that follows is presented as one example implementation of the teachings presented herein.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method implemented in a computer-readable storage medium and processed by a processor to perform the method, comprising:
receiving Structured Query Language (SQL) statements;
identifying a first rule and a second rule in the SQL statements; and
evaluating the first rule and the second rule against a database and providing results to other portions of the SQL statement for processing.

2. The method of claim 1, wherein receiving further includes interacting with a user via a graphical user interface to receive the SQL statements.

3. The method of claim 1, wherein identifying further includes parsing the SQL statements to identify the first rule as a first chain of rules.

4. The method of claim 3, wherein identifying further includes parsing the SQL statements to identify the second rule as a second chain of rules.

5. The method of claim 1, wherein evaluating further includes providing the results as a source to the other portions of the SQL statements.

6. The method of claim 1, wherein evaluating further includes providing the results as a driver to the other portions of the SQL statements.

7. The method of claim 1, wherein evaluating further includes evaluating the first rule and the second rule as components of a metric calculation to produce the results.

8. A method implemented in a computer-readable storage medium and processed by a processor to perform the method, comprising:
dynamically parsing Structured Query Language (SQL) statements to obtain a first rule and a second rule;
evaluating the first rule and the second rule against a database and summing first results from the first rule with second results from the second rule to produce combined results; and
using the combined results as input to other portions of the SQL statements when processing the other portions against the database.

9. The method of claim 8, wherein dynamically parsing further includes recognizing the first rule as a first set of rules that are to be evaluated when the first rule is processed.

10. The method of claim 9, wherein dynamically parsing further includes recognizing the second rule as a second set of rules that are to be evaluated when the second rule is processed.

11. The method of claim 8, wherein processing further includes producing the combined results as a source to the other portions of the SQL statements.

12. The method of claim 8, wherein processing further includes producing the combined results as a driver to the other portions of the SQL statements.

13. The method of claim 8, wherein processing further includes processing the first rule as a portion of a first metric calculation.

14. The method of claim 13, wherein processing further includes processing the second rule as another portion of the first metric calculation or a second and different metric calculation.

15. A computer-implemented system that executes on one or more processors, the system comprising:
a Structured Query Language (SQL) preprocessor implemented in a computer-readable storage medium and executed by a processor of a network; and
a data store implemented in a computer-readable storage medium and accessible to the SQL preprocessor;
wherein the SQL preprocessor iterates SQL statements to automatically and dynamically identify and evaluate multiple rules against the database to produce combined results that feed other portions of the SQL statements when those other portions of the SQL statements are processed.

16. The system of claim 15, wherein the SQL preprocessor iterates the SQL statements to process multiple sets of sub rules for each of the metric rules.

17. The system of claim 15, wherein the SQL preprocessor feeds the combined results as a source input to the other portions of the SQL statements.

18. The system of claim 15, wherein the SQL preprocessor feeds the combined results as a driver to the other portions of the SQL statements.

19. The system of claim 15, wherein the SQL preprocessor interacts with a user via a graphical user interface to interactively acquire the SQL statements.

20. The system of claim 15, wherein data store is a data warehouse that includes a collection of databases logically organized and accessible as a single unit.
